(19) United States
(12) Patent Application Publication
(10) Pub. No.: US 2022/0139242 A1
(43) Pub. Date: May 5, 2022

(54) Learning Using Continuous Spaced Repetition

(71) Applicant: Justin Y. Chen, Los Gatos, CA (US)

(72) Inventor: Justin Y. Chen, Los Gatos, CA (US)

(21) Appl. No.: 17/088,404

(22) Filed: Nov. 3, 2020

(51) Int. Cl. G09B 5/06; G09B 19/00

(52) U.S. Cl. CPC G09B 5/065; G09B 19/00

(57) ABSTRACT

A continuous spaced repetition method of learning that includes initiating a study session, where during a study session a learner reviews one or more cards from a set of cards that pertain to a subject material, each card includes a fact and a question concerning the fact, determining if there is one or more cards among the set of cards that is currently due, responsive to determining that one or more cards are due, selecting one of the one or more due cards, responsive to determining that no card is due either (1) selecting a card that is not yet due, or (2) selecting a new card, displaying the selected card to the learner, receiving a response by the learner to a question associated with the card, and determining a progress level for the selected card based on the accuracy of the response.

### BACKGROUND

Spaced repetition is a learning technique that improves learning effectiveness by presenting material to a learner with steadily increasing time intervals, until the learner masters the material. The time interval, or space, between successive repetitions increases with each repetition. Spaced repetition is a learning technique that is usually performed with flashcards. Newly introduced and more difficult flashcards are shown more frequently, while older and less difficult flashcards are shown less frequently.

The technique may be applied to many types of learning. For example, it has been used to learn vocabulary, math facts and history.

Computer programs that run on mobile devices, commonly referred to as apps, have become an important way to provide learning programs. The facts being memorized can be downloaded to the mobile device or can remain on a server computer and be provided on demand.

However, learners may use mobile devices in ways that are different than used for previous learning systems. For example, a learner may be switching between apps, for example to answer phone calls or to exchange text messages. This makes it difficult to control the timing of when material is presented.

Additionally, the standard spaced repetition algorithm may result in delay being imposed after a user reviews a set of cards before they can begin again. The algorithm doesn't allow for continuous study of the same material for arbitrary periods of time.

Thus, there is an opportunity to provide an improved method for learning on a mobile device that has the advantages of spaced repetition but addresses common use scenarios typically of mobile devices.

### SUMMARY OF THE DESCRIPTION

A novel technique, referred to as Continuous Spaced Repetition (CSR), is presented that is used to learn new information. The method is readily applied to the use of flashcards to present questions and answers, where the learner is trying to memorize facts. Additionally, it can be applied to other tasks, provided there is a way to evaluate the correctness of the task performed. For example, a task could be to pronounce a word correctly, or perform a short piano piece correctly. The use of “card” in this writing is an abstraction that refers to information provided to the learner and a question posed to the learner concerning the information included in the card.

One aspect of CSR is that the learner is not restricted to following a set schedule based on time, so their session can last any length of time, and they can continuously learn new material during the session and reach effective mastery of the new material even in short periods of time. This is especially useful when there is an imminent deadline such as an upcoming exam. Mastery of any given card can be achieved through continuous study, without depending on waiting for time intervals to elapse, which can unnecessarily delay the learning process. The repetition-based technique can also introduce new cards only when the learner has sufficiently mastered existing ones, which dynamically accounts for varying card difficulty.

The method retains much of the efficiency advantages of conventional spaced repetition, which means it performs much better than other systems such as random shuffling of flashcards. The cards that the learner repeatedly gets correct can be reviewed less often, which means that other cards can be studied more.

The invention includes a method for learning using continuous spaced repetition which includes initiating a study session, where during a study session a learner reviews one or more cards from a set of cards that pertain to a subject material, each card includes a fact and a question concerning the fact, determining if there is one or more cards among the set of cards that is currently due, responsive to determining that one or more cards are due, selecting one of the one or more due cards, responsive to determining that no card is due either (1) selecting a card that is not yet due, or (2) selecting a new card, displaying the selected card to the learner, receiving a response by the learner to a question associated with the card, and determining a progress level for the selected card based on the accuracy of the response, calculating an Initial Repetitions Until Due value for the card based on the progress level, setting a Current Repetitions Until Due value to equal the new Initial Repetitions Until Due value; and decrementing by one the Current Repetitions Until Due value for each of the cards under review.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1A-B are generalized block diagrams of preferred embodiments of systems that enable a learner to perform a Continuous Spaced Repetition (CSR) method of learning.

FIGS. 2A-B are embodiments of a user interface that enables a learner to perform a CSR method of learning.

FIG. 3 provides an exemplary flow diagram of a method that enables a learner to perform a CSR method of learning.

FIG. 4A is a balance graph that illustrates an example of a balanced saturation of cards relative to the Current Repetitions Until Due variable.

FIG. 4B is a balance graph that illustrates an example of a low saturation of cards relative to the Current Repetitions Until Due variable.

FIG. 4C is a balance graph that illustrates an example of a high saturation of cards relative to the Current Repetitions Until Due variable.

FIG. 5 illustrates one embodiment of the software modules that perform a CSR method of learning.

FIG. 6 illustrates an alternative embodiment of a CSR method of learning that maintains an ordered queue of cards.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Mobile device—refers to a smart phone that runs apps; however, it can also refer to a personal computer, gaming device or other computer system that includes a processor, display and keyboard and mouse or other interaction mechanism.

Learner or user—a person that uses a CSR system to learn subject material.

Subject material—refers to any set of facts or knowledge that can be learned using a CSR method, including inter alia languages, math, history, real estate practices, patent law and practices.

Card—refers to a panel or display area on a mobile device that presents to a learner a fact or item of information and an associated question to be answered by the learner.

Review or repetition—refers to the process of displaying a card to a learner, enabling the learner to study the card and to answer the associated question. Thus, a card has been reviewed after the question has been answered. The answer may be accurate, i.e. correct, inaccurate or incorrect or partially correct. In certain embodiments, there is an option for the learner to skip the question.

### Generalized Operation

The following description is based on a single learner that is using a CSR system to learn a subject material. It may be appreciated by one skilled in the art that a CSR system is typically used by many learners simultaneously and can offer many types of subject material for learning.

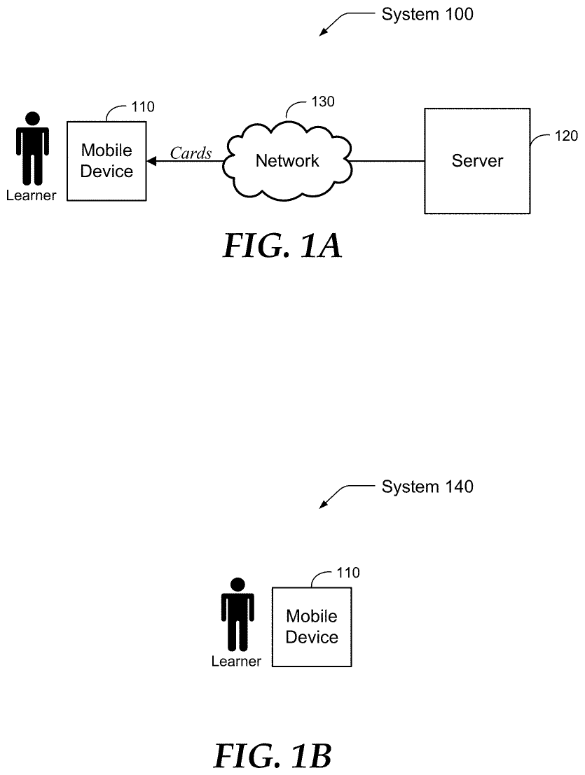

The operation of certain aspects of the invention is described below with respect to FIGS. 1-6.

FIGS. 1A-B are generalized block diagrams of preferred embodiments of systems that enable a learner to perform a Continuous Spaced Repetition (CSR) method of learning. FIG. 1A is a block diagram 100 that includes a mobile device 110, a server 120, and a network 130.

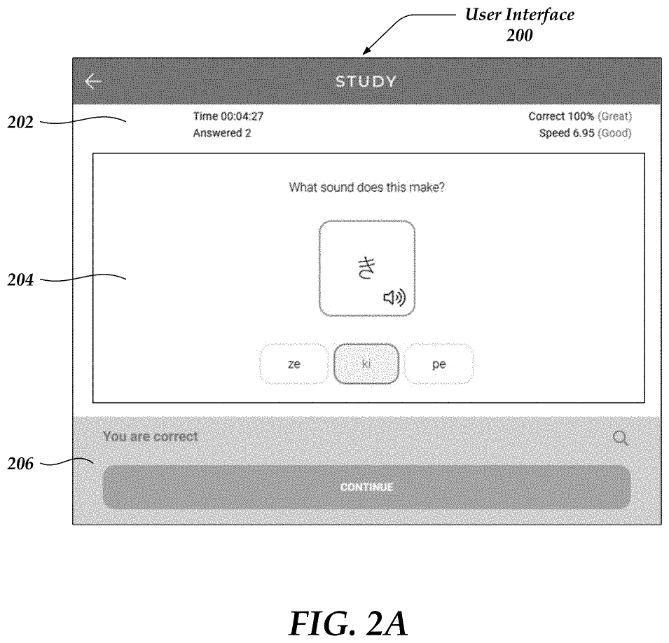

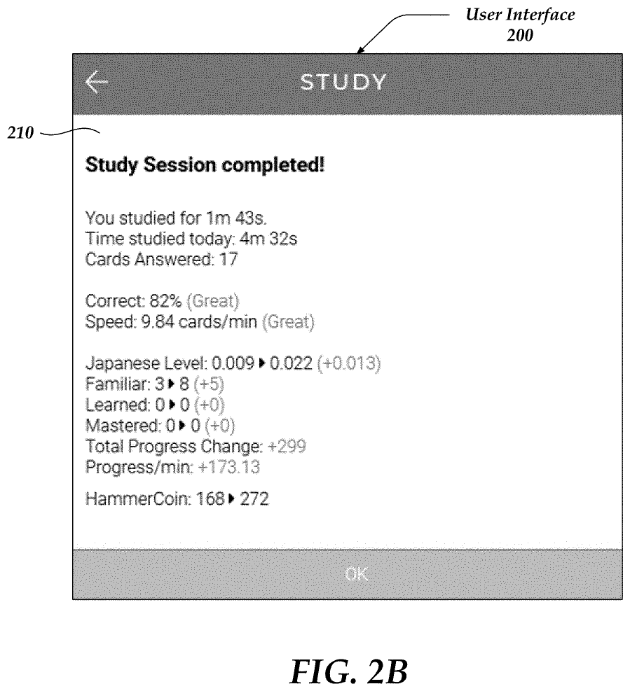

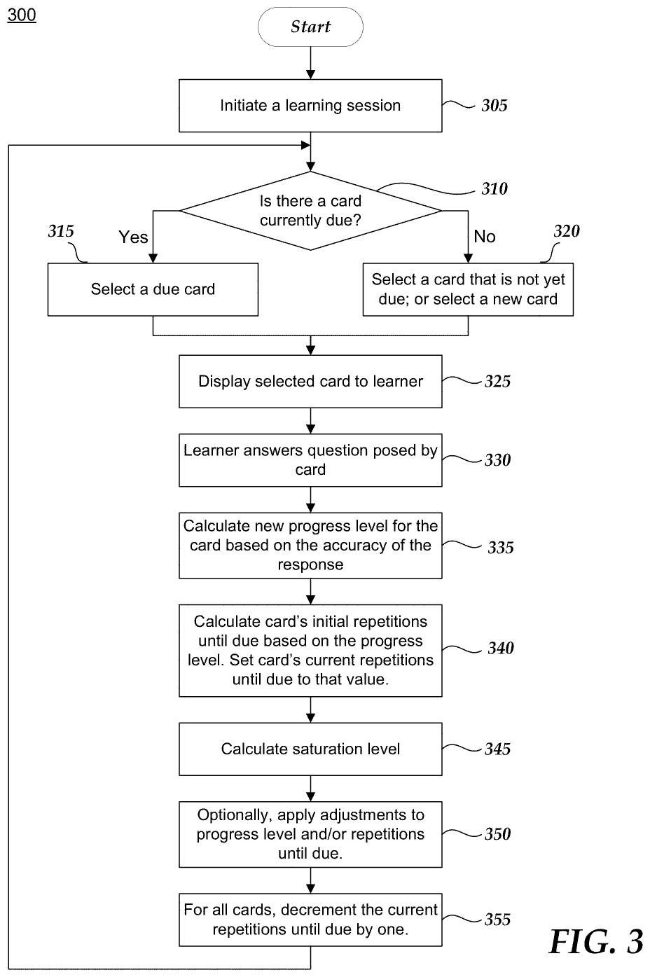

Mobile device 100 may be a smart phone such as an APPLE IPHONE or a SAMSUNG GALAXY or it may be another electronics device capable of performing a method described hereinbelow with reference to FIG. 3, implementing a user interface such as user interface 200, described hereinbelow with reference to FIG. 2, which interacts via a display with a learner and interacting with server computer 120 across network 130. Generally, mobile device 110 may be a smart phone, personal computer, tablet computer, or other computer system with a processor and non transitory memory for storing program instructions and data, a display and an interaction apparatus such as a keyboard and mouse.

Server computer 120 typically stores and provides data required by mobile device 110 to implement the method of FIG. 3. Typically, this include a database of cards that are displayed to users along with associated questions and any other required data. In certain embodiments, server computer 120 may perform some of the processing performed at various steps of the method of FIG. 3. Server computer 120 may be implemented by a single server computer, by multiple server computers acting cooperatively or by a network service, or “cloud” service provided by a cloud service provider. Devices that may operate as server computer 120 include, but are not limited to personal computers, desktop computers, multiprocessor systems, microprocessor-based or programmable consumer electronics, network PCs, servers, network appliances, and the like.

Network 130 enables mobile device 110 and server computer 120 to exchange data and messages. Network 130 may include the Internet in addition to local area networks (LANs), wide area networks (WANs), direct connections, combinations thereof or the like.

FIG. 1B illustrates an embodiment of a system 140 in which mobile device 110 operates in a standalone mode, i.e. it does not interact with server 120. One example of a use case of system 140 is when mobile device 110 is a smart phone, which downloads an app, across a network from an app store, which includes the instructions and data required to perform a CSR method. In other cases, mobile device 110 may be a device that includes a compact disc reader, a DVD reader or a flash memory reader and can load a program and data from physical media.

In each of FIGS. 1A-B, mobile device 110 displays instructions and visual feedback to a learner. It may be appreciated that such instructions and feedback may also be auditory and haptic.

FIGS. 2A-2B provide an embodiment of a user interface 200 that is used by a learner to learn subject material.

FIG. 2A is an embodiment of a user interface 200 in which a card s being presented to a learner. The card includes a top panel 202 that provides information about a learner session and about the card under review. A review panel 204 shows an item of data or information, associated with the card, that is to be reviewed or learned by the learner along with a question associated with the data. Generally, each card includes a data item and a question that concerns the card data. In this case, when the learner clicks one of the three alternative responses at the bottom of the panel, the depicted Japanese language character is pronounced. A lower results panel 206 indicates if the learner answered the question correctly and allows the learner to click “continue” to move to the next card.

FIG. 2B is an embodiment of user interface 200 that shows a summary panel 210 that presents the results of a study session.

### CSR Method

FIG. 3 provides an exemplary flow diagram of a method 300 that enables a learner to perform a CSR method of learning. The general framework under which the method operates is as follows:

Subject material is provided to a learner as a series of discrete cards. Each card poses a question related to a unit of information that the learner answers. For example, a unit of information may be a vocabulary word and the question might be to select the correct synonym or pronunciation.

Each card has an associated “progress level” value which reflects the learner's progress in learning the fact or unit of information associated with the card. In this embodiment, a higher progress level indicates that the learner has a better understanding of the card. A card's progress level increases when a learner answers the question posed by the card correctly and decreases when the learner answers incorrectly. For example, the progress level may increase by 10 when the card is marked correct and decrease by 10 when the card is marked incorrect. There can be options to mark a card as partially correct or incorrect, which may affect the amount that the progress level changes. The amount that the progress level changes (increases, decreases) may depend on various factors, such as the time taken to answer the card, the difficulty of the card, a learner's indicated confidence in the answer, and the time the learner takes to answer the question associated with the card.

After the learner answers the question associated with a card, a value referred to as Initial Repetitions Until Due is calculated for each card. In certain embodiments, the value is an exponentially increasing function of the card's progress level. In such embodiments, as the learner progresses in learning the facts associated with a card, i.e. the card's progress value increases, the number of repetitions increases exponentially. Initial Repetitions Until Due specifies how many other cards should be reviewed and answered by the learner before presenting this card again. Thus, the term repetition, or review/answer, refers to the steps of displaying a card to the learner, the learner looking at and studying the card and then answering the question associated with the card. The card becomes “due” after enough other cards have been reviewed and answered; i.e. when a card becomes due it is the turn of the card to be displayed to the learner. To keep track of the number of other cards that have been reviewed, i.e. the number of repetitions until due, a value referred to as Current Repetitions Until Due is maintained for each card. The value of Current Repetitions Until Due starts at the value of Initial Repetitions Until Due and is decremented after each repetition, i.e. after each other card is reviewed/answered by the learner.

Table 1, below, shows an example of the Initial Repetitions Unit Due associated with various progress levels. This example uses the value 1.072 as the exponential, i.e.

Initial Repetitions Until Due=Progress Level\hat{ }1.072. Equation 1

Note that Equation 1 give one example formula. Other formulas may be used without departing from the scope of the invention.

TABLE 1

| Progress Level | Initial Repetitions Until Due |
|---|---|
| 0 | 1 |
| 10 | 2.00423 |
| 20 | 4.01694 |
| 30 | 8.05088 |
| 40 | 16.1358 |
| 50 | 32.3399 |

At step 305 a learner initiates a learning session. For example, a user may run an app on mobile device 110 which enables them to pick up where they left off or to select a new type of subject material. If this is a fresh start, i.e. the learner is starting of with a new subject material, then all values are reset, i.e. the progress levels and the Initial and Current Repetitions Until Due values are set to zero. Also, the cards may be ordered, randomized, or ordered by the user. If the learner is resuming study on a particular subject material, the state of the previous session may be saved and reinstated or a fresh start may be made.

At step 310 a determination is made as to whether there is a card currently due. A card is determined to be due if its associated repetitions until due value is less than or equal to zero. Typically, all cards under review, i.e. cards that have been reviewed at least once by the learner, are arranged in a queue, which is ordered according to the Current Repetitions Until Due values of the cards in the queue.

At step 315 if one or more cards are due then one of the due cards is selected.

Various strategies may be used to select a card in the case where there is more than one card due, as discussed hereinbelow.

At step 320 if no cards are currently due then a card that is not currently due may be selected or a new card may be introduced. Strategies for selecting a card in this case are discussed hereinbelow.

At step 325 the selected card is displayed to the learner for review.

At step 330 the learner answers a question associated with the card. As illustrated in FIG. 2A a card typically includes a fact or data element for review and study and a question to be answered relative to the fact.

At step 335 a new progress level is computed for the card based on whether the question associated with the card is answered correctly by the learner. Typically, the a question is answered either correctly or incorrectly, but in certain embodiments, an answer may be partially correct, in which case the answer is accorded a numerical score such as a value in the range of 0 to 1 or 0 to 100.

At step 340 the selected card's Initial Repetitions Until Due value is calculated based on the progress level. For example, Equation 1 gives one formula that may be used for this calculation.

At step 345 an overall saturation level, as described hereinbelow, for all cards under review is calculated.

Optionally, at step 350 any of the values for progress level, Initial Repetitions Until Due and Current Repetitions Until Due may be adjusted based on a variety of factors. Some of the factors that may result in such adjustments being applied are discussed hereinbelow and generally fall within the categories of over saturation, under saturation, adjustments to progress level, learner ability, learner familiarity with cards, time gaps between learning sessions.

Finally, at step 355 the Current Repetitions Until Due value for each of the cards under review is decremented by one. Control then returns to step 310.

### Saturation and Under-Saturation

A value referred to as “saturation” or “saturation level” is calculated. In certain embodiments, the saturation level is calculated according to Equation 2 below:

saturation level=Σᵢ₌₁ to K[1/Initial Repetitions Until Due(card i)] Equation 2

where K is the number of different cards that have been reviewed by the learner.

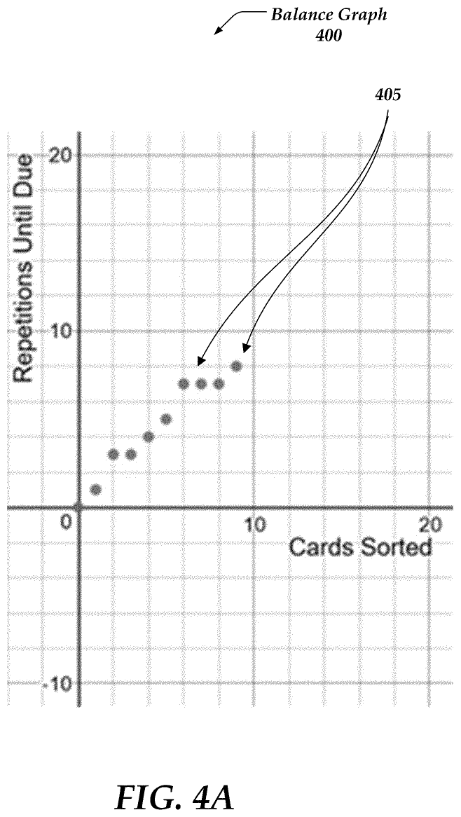

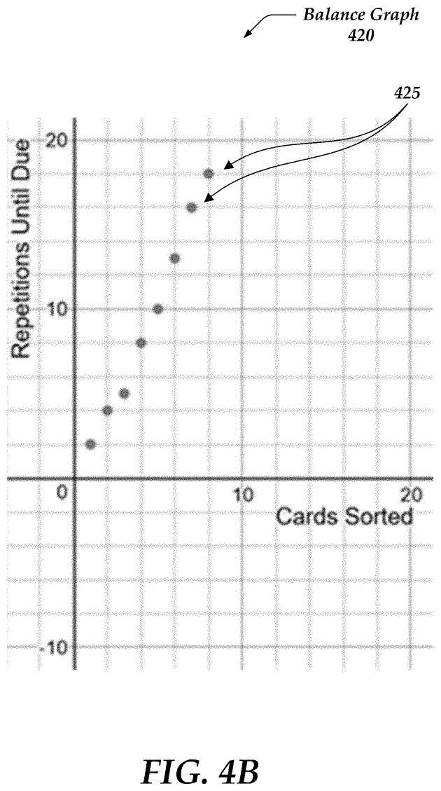

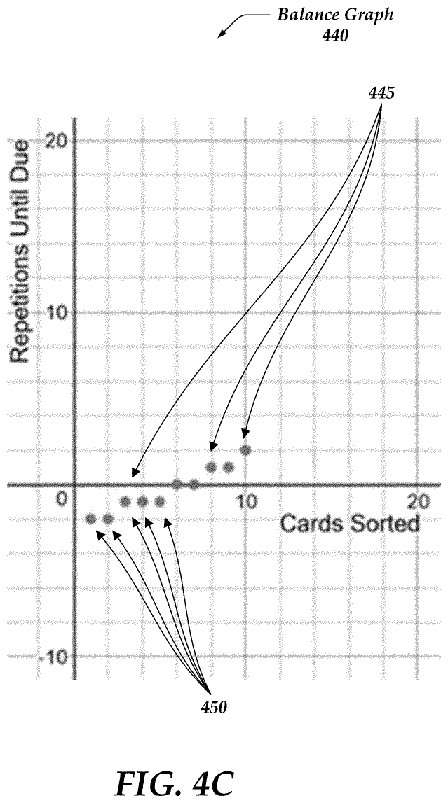

For example, if there are 2 cards with “Initial Repetitions Until Due” of 2, then saturation would be ½+½=1. The saturation level reflects whether the total “Initial Repetitions Until Due” sufficiently saturate the queue so that on average, there is a card currently due to be reviewed for each repetition or play. This state is referred to as a balanced saturation. However, if saturation is too low, there are not enough cards and there will be gaps where no cards are due. If saturation is too high, there are too many cards so cards will become “overdue”. It is ideal for the saturation level to be balanced, i.e. within a designated threshold value of 1; for example between 0.95 and 1.05 This ensures that most cards are displayed to the learner on time, i.e. when the Current Repetitions Until Due for a card reaches zero. FIGS. 4A-4C illustrate examples where the saturation level for a set of cards is balanced, too high and too low.

Method 300 attempts to present cards to the learner exactly when they are due. However, if there are too few cards being reviewed, there is a low saturation state, illustrated in FIG. 4B, and there will be times when no card is due yet, corresponding to step 320. As discussed, this presents an option to select a card that is not yet due (review a card early), or to select a new card. Selecting a new card has the effect of increasing the saturation since it adds another card to the calculation. Adding a new card has the advantage of increasing the saturation. Typically, when choosing to review a card early, the card closest to being due can be reviewed early. Reviewing a card early only increases the saturation if the learner answers the card wrong. To compensate for being reviewed early, the change in the card's progress level made after the learner answers the question associated with the card can, optionally, be reduced relative to the standard progress adjustment.

If there are too many cards being reviewed, there will be a high saturation state, illustrated in FIG. 4C, where there are too many cards coming due for the number of repetitions available, i.e. cards become due faster than the learner can study them.

Left alone, this situation will normally resolve itself as long as the learner's card progress levels increase on average, as the resulting “Initial Repetitions Until Due” will become longer, which means that the cards will be reviewed less often in the future. However, method 300 must decide which card to review when multiple cards are overdue. One option is to choose the card that is the most overdue. This is simple and ensures that all cards are reviewed eventually.

In certain embodiments, any “past due” cards are taken out of the review pool so they will not be selected for review. This ensures that the remaining cards are reviewed when they are due, which gives the learner a better chance of getting them correct and increasing their “Initial Repetitions Until Due”. When the saturation drops below 1, which means the learner is more comfortable with the current cards, a “past due” card can be brought back into the review pool.

To adjust for learner ability, it is possible to dynamically adjust any of the adjustable values, such as the amount added or subtracted from progress levels, the exponential value used I the calculation of the Initial Repetitions Until Due, as well as card selection strategy thresholds. For example, the amount added to progress levels can be adjusted, with higher values added if a learner is performing well, i.e. when the percentage of correct answers exceeds a threshold value. The initial repetitions formula could alternatively be adjusted to achieve a similar effect. Adjustments may be set manually by the learner, or automatically adjusted based on the learner's studying history and stated preferences, or the material that is being studied. In certain embodiments, values may be based on the performance of many learners on certain card sets and setting the values accordingly.

### Card Selection

As a learner studies, the average card progress levels are expected to increase as they memorize items, and therefore the saturation will decrease. Cards will start to be shown before they are due, which is inefficient. At this point, new cards are introduced to fill the gaps and bring the saturation closer to 1.

One strategy for introducing new cards is to do so whenever there is a “gap” where no cards are currently due. This results in a somewhat random introduction rate where several cards may be introduced in a row. It is possible to use a counter to space the new cards out so learners don't see too many new cards at once. The rate of new card introduction can increase when the saturation is lower.

Learners will typically have more difficulty memorizing some cards than others. Cards that are memorized will end up with higher progress levels, so eventually the learner will end up studying mostly cards that are “difficult”. This is somewhat good from a studying perspective, but not that good for learner motivation. One approach to resolving this potential problem is to occasionally give the learner some “easy” cards, i.e. show cards before they are due. This is less efficient for learning but may have a psychological benefit for certain learners.

When no cards are due, a new card can be introduced. However, if there are no new cards to introduce, or too many new cards have been introduced recently, then method 300 may show an existing card that is not due yet. There are several potential strategies on which card to choose. One strategy is to choose the card that is closest to being due. However, if a card has a low progress, then it may be picked repeatedly since it will be the closest to being due even after its “Current Repetitions Until Due” is reset. Another strategy is to choose the card that has the highest percentage of its total “Current Repetitions Until Due”/“Initial Repetitions Until Due” complete. This strategy is effective, but still has a similar problem where low progress cards are picked too often. A third strategy is to pick the card that has gone the longest without being reviewed. This strategy tends to pick high progress cards more often but prevents any cards from being seen too often. If a card is picked early, increasing its progress level by the full amount could be too much, as the learner didn't wait for the full “Initial Repetitions Until Due” so they haven't been properly tested. There is an option to reduce the progress level increase accordingly based on how much earlier the card was reviewed.

Sometimes, a learner may answer a particular card incorrect many times because they find the card particularly difficult. In such cases, the learner may spend a disproportionate amount time studying the card, as the progress level will remain low and the card will appear frequently. Depending on the goals of the learner, it may be beneficial sometimes to remove the card from the system, so that the learner can move on to other cards. This can be done automatically by tracking the number of times that the learner has gotten a card incorrect and removing the card accordingly. The learner may decide to modify the card to decrease its difficulty or spend additional time studying the card in isolation.

### Progress Level Adjustments

In certain embodiments, method 300 allows the learner to set the initial progress level of a card. For example, the learner can increase the exponential value used in calculating the Initial Repetitions Until Due value if they are familiar with the cards, ensuring that they won't be presented the same card for a larger number of repetitions. Setting a card's progress level to a high value has a negligible effect on saturation and allows a new card to be introduced quicker.

In certain embodiments, the “Initial Repetitions Until Due” of the card grows exponentially with progress level. This can cause problems with certain cards that the learner may typically get correct when reviews are common at low progress levels, but may be incorrect at high progress levels when the “Initial Repetitions Until Due” jumps to a much higher values. This may result in the card bouncing back and forth between two progress levels. One way to alleviate this is to count the number of times a card is incorrect, which reflects a learner's difficulty with a card. Based on this value, the system can gradually reduce the amount that the card's progress level changes when it is reviewed. This makes the jump in “Initial Repetitions Until Due” smaller, which prevents the previously described problem. However, if the progress level change becomes too small, it may take too long for the card to reach a high progress level, assuming the learner eventually memorizes the card properly. Conversely, if the learner completely forgets the card, its progress level would take too long to drop so that the learner could review it more thoroughly. For one way to account for this, the system tracks the consecutive correct or incorrect answers, and cancels out the previous effect as the learner gets more consecutive correct or incorrect answers. Essentially, if the learner gets it right or wrong every time, then the progress level change will accelerate back to normal speeds.

The amount that a card's progress level increases when the learner answers correctly, and how much the progress level decreases when the learner answers incorrectly, can be adjusted or calculated dynamically. There may be a different preferred value based on the learner's study abilities and the difficulty of the material. Higher overall values mean that the progress level will rapidly change, but the resulting “Initial Repetitions Until Due” may be larger, which may result in more incorrect answers in the future. Lower overall values mean that cards progress gradually increases which gives a smoother slope and fewer wrong answers, but it may be more inefficient if it is too low.

The ratio between the amount the card's progress level increases and how much it decreases can affect the probability that a learner gets a card correct. If the card's progress level increases by 10 for correct answer and drops by 20 for incorrect answer, the amount of correct answers will tend to become at least twice the incorrect ones, to maintain learning speed. If the ratio becomes too extreme, it may result in negative progress because learners will usually not be able to maintain a high correct rate during all study periods, due to distraction and other factors. One analysis of learners showed that a ratio around 10 correct to 15 incorrect resulted in more correct answers without affecting learning speed very much.

### Calibration Adjustments

The progress level of a card should roughly correspond to how well a learner knows a card, i.e. how likely they are to answer the question associated with the card correctly in the future. However, if a learner already has prior knowledge of the cards before using the method, then it can take some time to increase each card's progress level to the appropriate level. Tuning the progress level so it corresponds to the learner's knowledge of the card can be described as “calibration”. In certain embodiments, calibration is speeded up by temporarily increasing the magnitude of the progress level change when a card is answered correctly. For example, the progress level may increase by 50 instead of by 10. Then, once the learner answers the card incorrectly the progress level change returns to the normal rate.

An evaluation test can also be used to increase the calibration speed, under the assumption that there is some predictable relationship between the cards. For example, a language learner who knows vocabulary words of an intermediate difficulty can be expected to know most vocabulary words of a beginner difficulty. So, a test could be given to estimate the learner's approximate skill level and make assumptions about the progress level of a large number of cards as a result. If the cards' progress levels are set to a higher level because of this estimate, those cards will appear less frequently. As a result, the system will be able to introduce more cards earlier, and the learner will spend less time reviewing cards with subject material that they are already familiar with and can spend more time learning material they are less familiar with instead.

### Additional Adjustments

If the learner stops studying for a while, they may not remember as many cards when they start again due to the passage of time. This can be compensated for by decreasing the Current Repetitions Until Due value by some amount, so that the cards will become due earlier.

FIGS. 4A-C shows examples of what are referred to as balance graphs that illustrate a current status of cards under review, identified by the x-axis labeled “cards sorted”, relative to the variable Current Repetitions Until Due, given by the y-axis labeled “repetitions until due”.

FIG. 4A is a balance graph 400 that illustrates an example of a balanced saturation of cards 405 relative to the Current Repetitions Until Due variable. A balanced state typically results when saturation is around 1. No cards are overdue in this example.

FIG. 4B is a balance graph 420 that illustrates an example of a low saturation of cards 425 relative to the Current Repetitions Until Due variable. In this example, the cards have a high average repetitions until due. As cards are reviewed, there will be instances when there are no cards that are currently due. This is illustrated by the gaps that occur along the repetitions until due axis (y-axis) where there are certain y-axis values that have no corresponding cards. This is typically when new cards are introduced.

FIG. 4C is a balance graph 440 that illustrates an example of a high saturation of cards 445 relative to the Current Repetitions Until Due variable. In this example, cards 445 have a low average “Current Repetitions Until Due” and more cards are due at each repetition than can be reviewed. Five cards 450 have a “Current Repetitions Until Due” below 0, which indicates that they are already overdue.

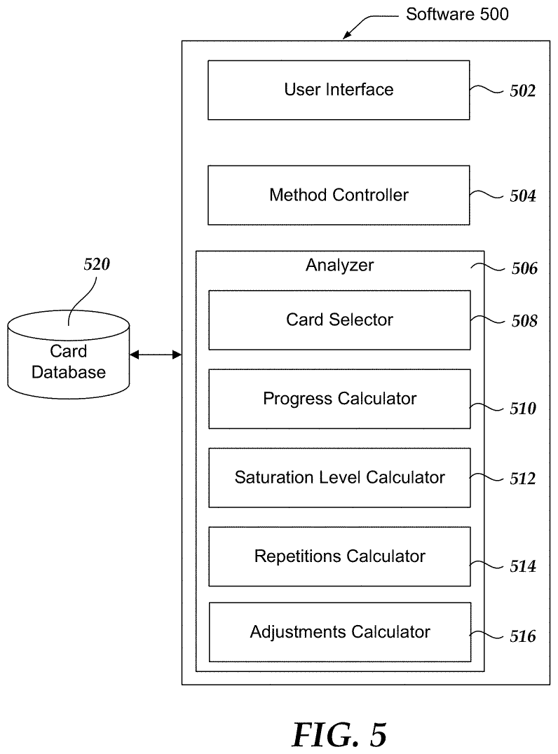

FIG. 5 illustrates one embodiment of the software modules 500 that perform a CSR method of learning. A user interface module 502 implements user interface 200. It presents cards to a learner and interacts with the learner to enable him/her to answer questions, review statistics, etc.

A method controller 504 implements method 300 by managing card queues and repetition information. An analyzer 506 module performs the various calculations required to implement method 300. It includes submodules that perform each separate calculation, including a card selector 508 that selects the next card to present to the learner, a progress calculator 510 that calculates the progress level for a card, a saturation level calculator 512 that calculates a saturation level at the end of each repetition, a repetitions calculator 514 that calculates the initial repetitions Until due and Current Repetitions Until Due values for a card at the end of a repetition, and an adjustments calculator 516 that performs any adjustments to progress level, Initial Repetitions Until Due and Current Repetitions Until Due for a card at the end of a repetition. Software 500 also includes a card database 520 that includes all cards for one or more subject materials.

### Final Considerations

It may be appreciated that CSR method 300 must be implemented on a computer system to be used practically. The Current Repetitions Until Due value must be tracked for every card that is being studied, and that value is decreased by 1 for every card every time the learner reviews a card. Since the method must accommodate very large numbers of cards a modern computer system is required to make the performance acceptable to a learner. For example, there are approximately it is typical to review several thousand vocabulary words when studying a new language language. Updating a card for each of 2,000-3,000 words in the mind or by hand would not be practical.

In addition, the initial repetitions until Due value must be calculated for the card that is being studied. The next card to study must be selected from the set of cards that has a “Current Repetitions Until Due” value of zero or lower. The number of calculations done would be completely impractical for any number of cards beyond a trivial amount and would severely interfere with studying if handled by the learner, so this system requires a computer to keep track of the data and make the calculations.

### Alternative Embodiment

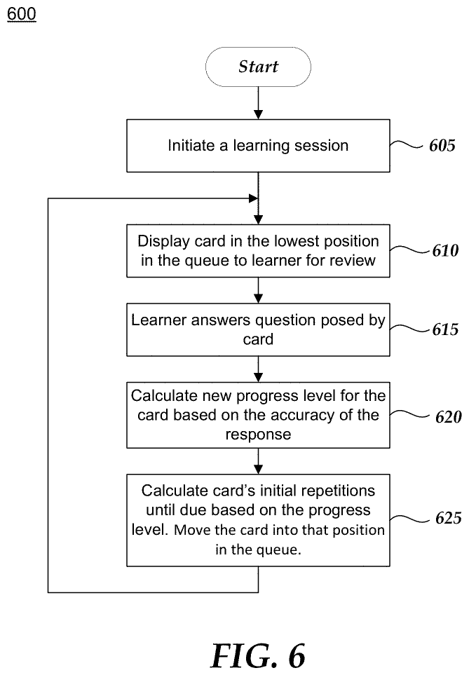

FIG. 6 illustrates a simplified, alternative, embodiment of a CSR method 600 that maintains an ordered queue of cards. Generally, the terminology and approach of method 600 is identical to that of method 300 except where specified below. Thus, similar to method 300, at step 605 a learning session is initiated, and a subject material is selected by a learner. A set of cards is associated with the subject material. The set of cards in the queue may be arbitrarily sorted initially, or they may be sorted according to degree of difficulty or another criterion.

At step 610 the learner is presented the card in the lowest position in the queue for review. For example, if there is a card in the 1^{st} position then it will be reviewed next; if there is no card in the first position but there is one in the second position, it will be reviewed next, and so forth. The learner reviews the card at step 615 and answers the question associated with the card.

At step 620 a new progress level is calculated for the card based on the accuracy of the response.

At step 625 an “Initial Repetitions Until Due” value is calculated according to the new progress level. The card is then inserted into the queue in spot. associated with the new Initial Repetitions Until Due value. For example, if the card has an Initial Repetitions Until Due of 5, it will be placed in the 5th spot in the queue, shifting any items in the queue behind it backwards one spot. Control then flows back to step 610.

This implementation is simple but has the disadvantage of not truly tracking the “repetitions until due” per card, so cards may not really appear after the expected number of repetitions. For example, if a card is put in the 5th spot, but proceeding cards are put in the 2nd and 3rd spot, they will push the first card backwards and it will not be reviewed until 7 repetitions instead of 5. For another example, if a card is supposed to be put in the 100th spot but there are only 50 cards, then there will not be 50 cards to review before it so it may be reviewed earlier than the expected 100 repetitions.

Method 600 allows there to be gaps in the queue. In other embodiments, there are no gaps in the queue. Gaps can be eliminated, for example, by requiring that after a card is reviewed, the Initial Repetitions Until Due is calculated as in method 600; then if the calculated value is higher than the total positions in the queue, the card placed at the last available position in the queue, i.e. the last position where there is no card.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for progress-based learning, comprising:
initiating a study session, wherein during a study session a learner reviews one or more cards from a set of cards that pertain to a subject material, each card including a fact and a question concerning the fact, wherein reviewing a card comprises displaying the fact and the question to the learner and receiving an answer to the question from the learner and wherein each card has an associated progress level, Initial Repetitions Until Due value and a Current Repetitions Until Due value;
determining if there is one or more cards among the set of cards that is currently due;
responsive to determining that one or more cards are due, selecting one of the one or more due cards;
responsive to determining that no card is due either (1) selecting a card that is not yet due, or (2) selecting a new card;
displaying the selected card to the learner;
receiving a response by the learner to a question associated with the card;
determining a new progress level for the selected card based on the accuracy of the response;
calculating a new Initial Repetitions Until Due value for the card based on the new progress level;
setting a new Current Repetitions Until Due value to equal the new Initial Repetitions Until Due value; and
decrementing by one the Current Repetitions Until Due value for each of the cards under review.

2. The method of claim 1 wherein initiating a study session comprises:
selecting, by the learner, a subject material to study; and
setting the associated progress level for each of the set of cards that correspond to the subject material to zero.

3. The method of claim 1 wherein the card is due when the Current Repetitions Until Due value equals zero.

4. The method of claim 1 wherein selecting a new card comprises selecting a card from the set of cards that hasn't yet been reviewed by the learner.

5. The method of claim 1 wherein determining a new progress level comprises adding a first designated number to the current progress level value if the question was answered correctly and subtracting a second designated number from the current progress level value if the question was answered incorrectly.

6. The method of claim 1 wherein calculating a new Initial Repetitions Until Due value for a card comprises raising the new progress level by an exponential value.

7. The method of claim 1 further comprising:
calculating a saturation level across all cards that have been reviewed by the learner;
responsive to the saturation level being less than a threshold value below one and responsive to there being no card due selecting a card that is not yet due; and
responsive to the saturation level being greater than a threshold value above one, selecting the card with the smallest Current Repetitions Until Due value.

8. The method of claim 7 wherein the saturation level is calculated according to the formula
saturation level=Σᵢ₌₁ to K[1/Initial Repetitions Until Due(card i)],
where K is the number of different cards that have been reviewed by the learner.

9. The method of claim 1 further comprising enabling the learner to set the progress value for a card the first time they review it.

10. The method of claim 1 further comprising:
counting the number of times the learner answers the card incorrectly; and
removing the card from the set of cards when the number of times exceeds a threshold value.

11. The method of claim 5 further comprising:
increasing the progress level for a card by the first designated value each time the learner correctly answers the question associated with the card; and
upon incorrectly answering the associated question, increasing the progress level for a card by a second designated value each time thereafter that the learner correctly answers the question.

12. The method of claim 1 further comprising:
partitioning the set of cards into skill levels;
enabling the learner to review cards at each skill level; and
setting a progress level for each card in each partition of cards based on the rate of success of the learner in answering cards for the corresponding partition.

13. A computer-implemented method for progress-based learning, comprising:
initiating a study session, wherein during a study session a learner reviews one or more cards from an ordered queue of cards that pertain to a subject material, the queue containing sequentially numbered positions from low to high, wherein each card includes a fact and a question concerning the fact, wherein reviewing a card comprises displaying the fact and the question to the learner and receiving an answer to the question from the learner, and wherein each card has an associated progress level, and an Initial Repetitions Until Due value;
displaying the card in the lowest position in the queue to the learner;
receiving a response by the learner to a question associated with the card;
determining a new progress level for the card based on the accuracy of the response;
calculating a new Initial Repetitions Until Due value for the card based on the new progress level;
responsive to determining that there is a card in the position in the queue that corresponds to the Initial Repetitions Until Due value, increasing the position of the card in the position in the queue that corresponds to the Initial Repetitions Until Due value and all other cards in the queue with a higher position by one; and
moving the card into the position in the queue that corresponds to the Initial Repetitions Until Due value.
